(19) United States
(12) Patent Application Publication
(10) Pub. No.: US 2013/0125231 A1
(43) Pub. Date: May 16, 2013

(54) Method and system for managing a multiplicity of credentials

(71) Applicant: Adam Kuenzi, Silverton, OR (US)

(72) Inventor: Adam Kuenzi, Silverton, OR (US)

(73) Assignee: UTC Fire & Security Corporation, Farmington, CT (US)

(21) Appl. No.: 13/373,438

(22) Filed: Nov. 14, 2011

(51) Int. Cl. H04L 9/32

(52) U.S. Cl. 726/16

(57) ABSTRACT

A wireless key device is configured to execute a digital credential management method to manage a plurality of digital credentials. According to this digital credential management method, the wireless key device polls an access terminal for an access terminal identification which uniquely identifies the access terminal. The wireless key device identifies a filter based on the access terminal identification, and selects a subset of the plurality of digital credentials based on the filter. The wireless key device renders a list of the subset of the plurality of digital credentials on a display, receives a user input selecting one of the subset of the plurality of digital credentials, and transmits the selected credential to the access terminal.

### BACKGROUND

The present invention relates generally to access control systems, and more particularly to a system for managing a multiplicity of digital credentials.

Digital credentials contain information usable by an access point or access terminal to determine whether a user is permitted access to a particular location, service, or function. Digital credentials are typically associated with a user ID or account, or with a user class. A digital credential required for access to a restricted facility on a college campus might, for instance, be associated with an individual student of faculty member, or might be a general credential used by all faculty, or by a particular group of students. Digital credentials contain validation mechanisms which may vary in complexity from simple passcodes to more sophisticated keys for complex encryption procedures.

Traditional digital credentials include physical cards or tags stored in a physical wallet. Although some RFID cards, for instance, may be detected in proximity to a card reader, others must be physically retrieved and swiped or otherwise activated with each use. Physical credentials are easily lost or damaged, and are increasingly being replaced with virtual digital credentials stored on a key device such as a smartphone. Virtual credentials are more easily provided, replaced, and updated than physical credentials.

Digital credentials are used in a wide range of applications, from digital banking to access control. A credentialed user may, for instance, use a near field communication (NFC) capable smartphone to access restricted areas on company or government property, or to access digital materials to which access is similarly restricted. Similarly, a user may provide an electronic banking credential to a point-of-sale terminal when making a purchase. In most conventional systems, access terminals, which receive digital credentials from a user, transmit these credentials to a remote server such as a credit card or electronic banking clearance server, or an access control management server. This remote server validates the credential, ascertaining, for instance, whether the user has permission to access a particular area at a particular time, or whether the user has sufficient available funds to make a purchase. This determination is then provided to the access terminal, which accepts or rejects the user activity accordingly.

It is not unusual for a single user to utilize digital credentials for a wide range of different purposes and locations, and the number of such applications is likely to increase as the use of digital credentials becomes more widespread. Each credential can include or be associated with multiple permissions, allowing a single credential to be used for a plurality of functions. This “federated access” approach is popular with large institutions such as governments, universities, and large corporations. Federated access systems allow some users to dramatically reduce the number of digital credentials they routinely utilize. For many users, however, federated access is not practical, or is not a complete solution, either because no single organization controls or manages most of that user's credentials, or because even large institutions often utilize a multitude of separate systems for different facilities or tasks.

Users who use digital credentials for a multiplicity of tasks are therefore likely to possess a large number of separate digital credentials. Some conventional systems organize all of a user's credentials in a digital wallet on a wireless device such as a smartphone, from which users manually select the appropriate credential for each task. This process is time consuming, particularly if users must produce credentials frequently.

### SUMMARY

The present invention is directed toward a wireless key device configured to execute a digital credential management method to manage a plurality of digital credentials. According to this digital credential management method, the wireless key device polls an access terminal for an access terminal identification which uniquely identifies the access terminal. The wireless key device identifies a filter based on the access terminal identification, and selects a subset of the plurality of digital credentials based on the filter. The wireless key device renders a list of the subset of the plurality of digital credentials on a display, receives a user input selecting one of the subset of the plurality of digital credentials, and transmits the selected credential to the access terminal.

### BRIEF DESCRIPTION OF THE DRAWINGS

FIG. 1 is a system diagram of a user authentication system.

FIG. 2 is a block diagram of an electronic lock portion of the user authentication system of FIG. 1

FIG. 3 is a flowchart of a credential management method performed by the user authentication system of FIG. 1.

### DETAILED DESCRIPTION

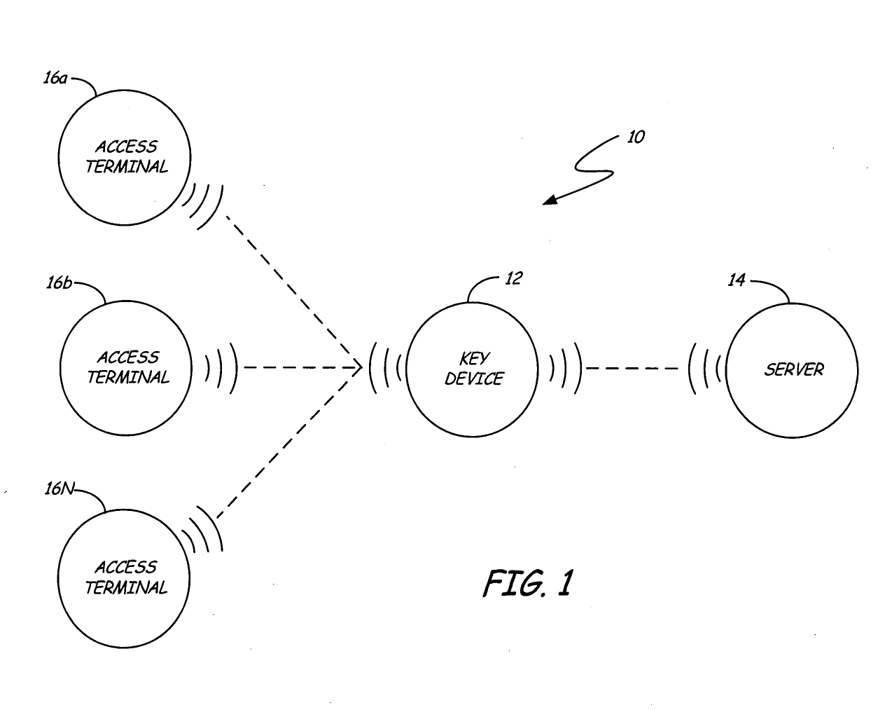

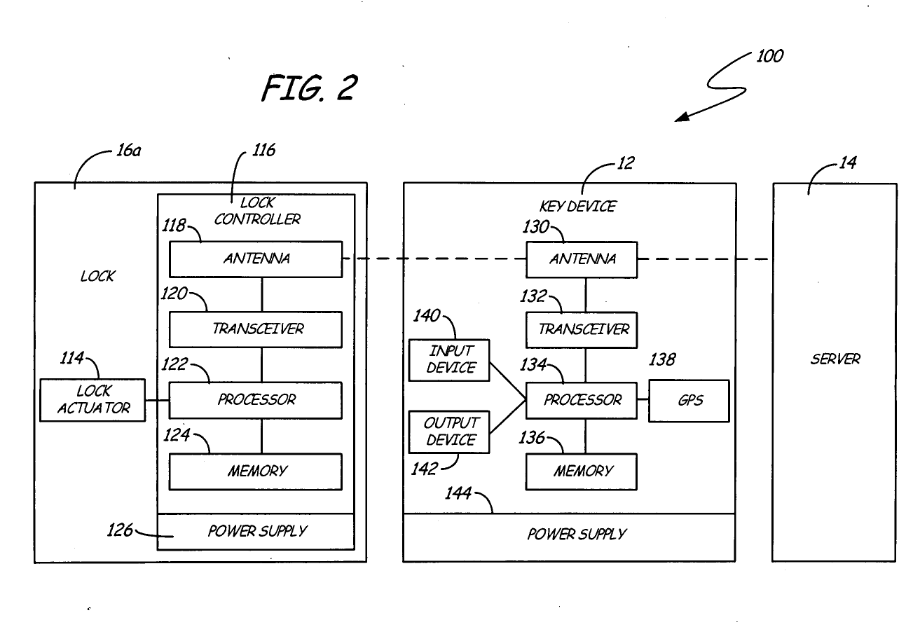

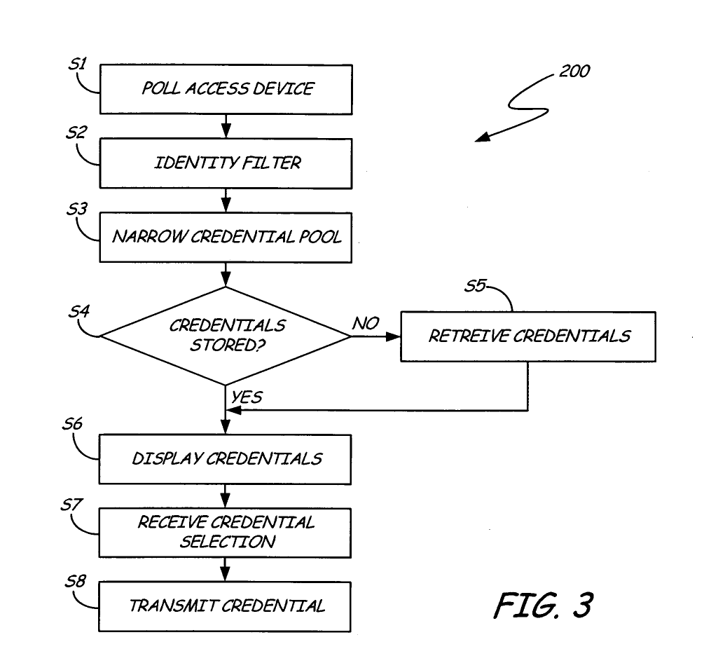

FIG. 1 is a block diagram of user authentication system 10, comprising key device 12, server 14, and a plurality of access terminals 16 (including access terminal 16a, access terminal 16b, and access terminal 16N). Key device 12 is a wireless capable handheld device such as a smartphone, which receives digital credentials from server 14, a remote certification server. Server 14 may also provide other data to key device 12, such as firmware or software updates. Although server 14 is described herein as a single device, a person skilled in the art will recognize that server 14 may alternatively be embodied as a multiplicity of server devices from which key device 12 receives credentials and other data. Access terminals 16 are wireless-capable restricted-access or restricted-use devices such as wireless locks, electronic banking terminals, data transfer devices, and restricted-use machines. Key device 12 provides credentials to access terminals 16, thereby enabling a user to access or activate functions of access terminals 16. A user may, for instance, submit a digital credential to an electromechanical lock to unlock it, and thereby gain access to a restricted area. In another example, a user may submit a digital credential to an electronic banking terminal to withdraw or deposit funds, or allow access to account information. Some credentials may be used for multiple access terminals 16. For instance, a plurality of electronic locks in a facility may respond to the same credential. Other credentials may be specific to a single access terminal 16. A user may utilize a large number of credentials to access the plurality of access terminals 16. To facilitate selection of appropriate credentials for each access terminal, the key device 12 is provided with a credential management system, as described with respect to FIGS. 2 and 3.

FIG. 2 is a block diagram of electronic lock system 100, comprising lock 16a, key device 12, and server 14. Lock 16a comprises lock actuator 114, and lock controller 116 with lock antenna 118, lock transceiver 120, lock processor 122, lock memory 124, and lock power supply 126. Key device 12 comprises key antenna 130, key transceiver 132, key processor 134, key memory 136, GPS receiver 138, input device 140, output device 142, and key power supply 144.

Lock 16a is a lock responsive to digital credentials from key device 12, and is an example of one possible access terminal 16 (see FIG. 1). Lock 16a may, for instance, be the lock of a lockbox, a door lock, or a lock core. Although the present disclosure focuses primarily on digital credentials used in access control, a person skilled in the art will recognize that the invention may also be applied to other systems wherein digital credentials are transmitted from a key device to a wireless terminal so as to identify the user or validate user permissions. Such systems include virtual or electronic banking systems, machine operation systems, and data access systems. Upon receiving and authenticating appropriate digital credentials from key device 12, lock controller 116 commands lock actuator 114 to lock or unlock a mechanical or electronic lock. Lock 16a may, for instance, be a digital lock core, keypad, or digital lock. Lock controller 16a and lock actuator 114 may be parts of a single electronic or electromechanical lock unit, or may be components sold or installed separately. Lock transceiver 120 is a conventional transceiver capable of transmitting and receiving data to and from at least key device 12. Lock transceiver 120 may, for instance, be a near field communication (NFC), Bluetooth, or WiFi transceiver, or another appropriate wireless transceiver. Lock antenna 118 is an antenna appropriate to lock transceiver 120. Lock processor 122 and lock memory 124 are conventional data processing and storage devices, respectively. Lock processor 122 may, for instance, be a microprocessor. Lock power supply 126 is a power source which powers other elements of lock controller 16, and in some embodiments also powers lock actuator 114. In other embodiments, lock power supply 126 may only power lock controller 116, leaving lock actuator 114 to be powered primarily or entirely by another source, such as user work (e.g. turning a bolt). By way of example, lock power supply 126 may be a line power connection, a power scavenging system, or a battery.

Key device 12 is a wireless capable handheld device such as a smartphone, as explained above with respect to FIG. 1. Key transceiver 132 is a transceiver of a type corresponding to lock transceiver 120, and key antenna 130 is a corresponding antenna. In some embodiments, key transceiver 132 and key antenna 130 may also be used to communicate wirelessly with server 14. In other embodiments, one or more separate transceivers and antennas may be included to communicate with server 14.

Key processor 134 is a microprocessor or analogous logic processor which handles digital credentials, and submits these credentials to lock processor 120 via intervening antennas and transceivers 118, 120, 130, and 132. Key memory 136 is a memory array wherein digital credentials are stored. Key memory 136 may, for instance, be secure memory, a SIM card, or any other type of secure storage or conventional memory for a portable device. Key memory 136 may be multipurpose memory available for a variety of other tasks performed by key device 12. In some embodiments, lock processor 134 is capable of determining a geographic position of key device 12. Lock processor 134 may, for instance, receive a position signal from GPS receiver 138. Alternatively, lock processor 134 may triangulate a position from cellular towers, or assume a last known location, such as the known location of the last access terminal accessed by key device 12. Key processor 134 receives user input via input device 140, and provides information to users via output device 142. Input device 140 may, for instance, be a keypad or touch screen. Output device 142 may be a display, audio output, or analogous output mechanism. Key power supply 144 is power source such as a battery, which powers all components of key device 12.

To obtain access to a region protected by lock 16a, a user must provide lock controller 116 with a valid digital credential indicating that such access is permitted. Digital credentials may be associated with individual users, or with classes of users. Each user may possess a large number of credentials for different applications, such as electronic banking and access control. Digital credentials are retrieved from server 14. In some embodiments of the present invention, digital credentials are retrieved periodically or upon user request In other embodiments, key device 12 may receive digital credentials in response to events such as entering a geographic area, or requesting access to a restricted area. At any point in time, key memory 136 may store a plurality of digital credentials, and may further store indicators that an additional plurality of digital credentials are available for retrieval from server 14. Processor 145 performs a credential management software method. This credential management method automatically selects a subset of these digital credentials for use, by polling lock controller 116 for an access terminal ID, and potentially also based on other information as described below with respect to FIG. 3. Where the total number of digital credentials (locally stored or remotely available from server 14) is large, this credential management method facilitates easier and faster credential selection and provisions.

FIG. 3 is a flowchart of credential management method 200, comprising steps S1 through S8. First, key device 12 polls an access terminal 16 (such as lock controller 116, as discussed above with respect to FIG. 2) in response to entering a physical or geographic vicinity of access terminal 16a, or in response to a user prompt. (Step S1). Access terminal 16a provides an access terminal ID in response to the polling message from key device 12. This access terminal ID uniquely identifies the access terminal, and may be a globally unique ID (GUID) such as an IEEE defined identifier allocated by an industry intermediate party, or an ID managed by a particular organization. This access terminal ID may, for instance, be an Ethernet MAC address, an RFID identifier, a Bluetooth address, or a UPC code. Each digital credential is associated, prior to use, with one or more access terminal IDs, and may contain an access terminal ID.

Access terminal 16a may be polled, and the access terminal ID retrieved, in a variety of ways, depending on the type of wireless connection available between access terminal 16a and key device 12. Where access terminal 16a and key device 12 communicate by NFC, for instance, key device 12 and access terminal 16a may both operate in peer-to-peer mode, or key device 12 may operate in reader mode while access terminal 16a operates in tag mode, functioning on induced power from key device 12. The access terminal ID may, for instance, be an ID read from access terminal electronics, or read from a radio-frequency identification (RFID) or NFC tag. Alternatively, key device 12 may read the access terminal ID from a bar code or label on access terminal 16b via input device 140, or receive the access terminal ID by means of manual user input via input device 140. In yet another alternative embodiment, key device 12 may communicate with access terminal 16a using Bluetooth or Wi-Fi, such that the access terminal ID is a MAC address of access terminal 16a. Key device 12 may communicate with each access terminal 16 via different means.

Key device 12 (and particularly key processor 134) next creates or identifies a filter based on the access terminal ID (Step S2). This filter is used to define a subset of all of the user's credentials potentially applicable to access terminal 16a. (Step S3). This filter may exclude all credentials not previously associated with the access terminal ID of access terminal 16a, or may exclude only a subset of such credentials. This filtering process produces a narrowed credential pool.

Processor 134 next determines whether all digital credentials in the narrowed credential pool are stored locally in key memory 136. (Step S5). If any digital credentials are missing from key memory 136, processor 134 requests these credentials from server 14 via transceiver 132 and antenna 130. Upon receiving requested credentials, or upon determining that all credentials in the narrowed credential pool are already present in key memory 136, processor 134 may, in some embodiments, provide a list of all credentials in the narrowed pool via output device 142. (Step S6). Processor 134 may, for instance, render this list as a graphical list of credentials on a smartphone display, or may list credentials via an audio recitation. A user presented with such a list can select a credential from the narrowed pool via the input device, for instance by tapping on an icon representing the appropriate credential on a touch screen, or speaking the name or another identifier of the appropriate credential into a microphone. Processor 134 of key device 12 processes this user input to identify the selected credential (Step S7), and transmits the selected credential to access terminal 16, which may then utilize the selected credential for access control, electronic banking, or other functions, as appropriate.

Although the preceding description assumes that all credentials in the narrowed pool are retrieved prior to providing a user with a list of credentials in the narrowed pool via output device 142 (Step S6), this need not be the case. In some embodiments, processor 134 provides the list while some or all credentials are still missing from key memory 136, and subsequently retrieves only the digital credential identified by the user selection received in step S6. This conserves bandwidth by retrieving digital credentials from server 14 only on an as-needed basis, but correspondingly delays a user's ability to access access terminal 16, since digital credentials are not retrieved ahead of time. Additionally, this alternative method may be impracticable if access terminal 16 is positioned in a location from which key device 12 cannot reliably contact server 14. Different situations may make one alternative more attractive than the other, key device 12 may utilize a mix of the two methods as appropriate. Key device 12 may, for instance, preload most long-lasting credentials, but decline to preload credentials which are infrequently used, or which frequently change (e.g. credentials which must be updated hourly). In some embodiments, processor 134 may detect that key device 12 is in the geographic vicinity of access terminal 16a from a GPS signal received via GPS receiver 138, and begin downloading the digital credential associated with access terminal 16a in response.

In many cases, the access terminal ID received in step S1 may be sufficient to uniquely identify a digital credential (i.e. if the user does not have multiple alternative digital credentials for access terminal 16a). In such cases, key device 12 may submit this (sole) digital credential in the narrowed pool to a user for validation in steps S6 and S7, or may skip steps S6 and S7 altogether. Even where the access terminal ID is not sufficient to uniquely identify a digital credential, however, user input may not always be needed. In some embodiments, a user favorite credential or credential preferences can be saved in key memory 136, allowing processor 134 to select a credential from the narrowed credential pool without input from the user (see steps S6 and S7, above). This favorite credential or credential preference may comprise a credential specifically pre-selected by the user, a last-used credential remembered by key memory 136 from a previous interaction with lock 16a, or a ranking of credentials in order of user preference, based either on explicit user input or on past activity. In some cases user input may be requested to confirm a credential selected in this way. In yet another embodiment, key device 12 transmits each of the digital credentials in the narrowed credential pool, one by one, until one credential is accepted by access terminal 16a. According to this approach, access terminal 16a distinguishes between invalid credentials (which may trigger a user or access terminal lockout) and valid but inapplicable credentials (which neither authorize access nor trigger lockout). This approach may be combined with the credential preference system described above, such that preferred credentials are tried first.

The present invention allows for the automatic selection or facilitation of selection of a user credential from a set of credentials, thereby saving time and reducing complexity for the user. According to the present system, access terminal 16 may communicate directly with key device 12, and accordingly need not be provided with any direct access to server 14, or to other non-local devices.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wireless key device comprising:
a wireless transceiver and antenna configured to communicate wirelessly with an access terminal;
an input device configured to receive user input;
an output device having a display; and
a processor configured to:
poll the access terminal via the wireless transceiver and antenna for an access terminal identification which uniquely identifies the access terminal;
identify a filter based on the access terminal identification;
select a subset of the plurality of digital credentials based on the filter;
select a first digital credential from the subset of the plurality of digital credentials; and
transmit the first single credential to the access terminal via the wireless transceiver and antenna.

2. The wireless key device of claim 1, wherein the selecting a single credential comprises:
rendering a list of the subset of the plurality of digital credentials on the display; and
receiving a user input via the input device, the user input selecting one of the subset of the plurality of digital credentials.

3. The wireless key device of claim 1, wherein the processor is further configured to select and individually transmit additional credentials from the subset of the plurality of digital credentials, if the first credential is not accepted.

4. The wireless key device of claim 1, wherein the selecting the single credential comprises selecting a favorite or previously user-selected credential from the subset of the plurality of digital credentials.

5. The wireless key device of claim 1, wherein the wireless transceiver and antenna are a near field communication transceiver and antenna, respectively.

6. The wireless key device of claim 1, wherein the processor is further configured to retrieve at least one among the plurality of digital credentials from a server.

7. The wireless key device of claim 6, wherein retrieving at least one among the plurality of digital credentials comprises retrieving the selected credential upon receiving the user input.

8. The wireless key device of claim 6, wherein retrieving at least one among the plurality of digital credentials comprises retrieving the subset of the plurality of digital credentials from a server after selecting the subset of the plurality of digital credentials.

9. The wireless key device of claim 1, wherein the processor is further configured to ascertain a location via GPS, and wherein the at least one among the plurality of digital credentials is retrieved in response to the ascertained location falling close to a known location of the access terminal.

10. A user authentication system comprising:
an access terminal configured to receive a first digital credential for validation; and
a key device comprising a wireless transceiver, a credential memory configured to store a plurality of credentials, and a processor configured to:
poll the access terminal via the wireless transceiver for an access terminal ID which uniquely identifies the access terminal;
identify a filter based on the access terminal ID;
select, from among the plurality of digital credentials, a subset of digital credentials including the first digital credential, based on the filter; and
transmit the first digital credential to the access terminal via the wireless transceiver.

11. The user authentication system of claim 10, wherein the access terminal ID specifically identifies the first credential, and the selected subset of digital credentials includes only the first digital credential.

12. The user authentication system of claim 10, wherein the access terminal ID is a near field communication or radio frequency identification tag.

13. The user authentication system of claim 12, wherein the access terminal operates in a tag mode, and the wireless key device operates in a reader mode.

14. The user authentication system of claim 10, wherein the access terminal and the wireless key device both operate in peer-to-peer mode.

15. The user authentication system of claim 10, wherein the access terminal is a wireless lock.

16. The user authentication system of claim 10, wherein the access terminal is an electronic banking terminal.

17. The user authentication system of claim 10, further comprising a screen and an input device, and wherein the processor is further configured to:
render a selection display of the subset of digital credentials on the screen; and
receive a user input via the input device, selecting the first digital credential from among the subset of digital credentials.

18. The user authentication system of claim 10, wherein the access terminal directly communicates only with the key device and other key devices.

19. A method of managing digital credentials for a wireless key device, the method comprising:
retrieving an access terminal ID from an access terminal, the access terminal ID uniquely identifying the access terminal;
identifying a filter based on the access terminal ID;
selecting a subset of the plurality of digital credentials based on the filter;
rendering a list of the subset of the plurality of digital credentials, on a display;
receiving a user input selecting one of the subset of the plurality of digital credentials; and
transmitting the selected credential to the access terminal.

20. The method of claim 19, wherein retrieving the access terminal ID from the access terminal comprises communicating with the access terminal by means of near field communication (NFC), and wherein the access terminal ID is a NFC tag.

21. The method of claim 19, wherein retrieving the access terminal ID from the access terminal comprises communicating with the access terminal via Bluetooth or Wi-Fi, and wherein the access terminal ID is a MAC address.

22. The method of claim 19, wherein retrieving the access terminal ID is ascertainable from a bar code or label on the access terminal.

23. The method of claim 19, wherein the access terminal directly communicates only with the key device and other key devices.
